(19) United States
(12) Patent Application Publication
(10) Pub. No.: US 2021/0027453 A1
(43) Pub. Date: Jan. 28, 2021

(54) COMPUTER DEVICE AND METHOD FOR PROCESSING IMAGES OF PRODUCTS BASED ON PRODUCT EXAMINATION USING MONOCHROMATIC LIGHTS

(71) Applicants: Fu Tai Hua Industry (Shenzhen) Co., Ltd., Shenzhen (CN); HON HAI PRECISION INDUSTRY CO., LTD., New Taipei (TW)

(72) Inventor: JUNG-YI LIN, New Taipei (TW)

(21) Appl. No.: 16/699,940

(22) Filed: Dec. 2, 2019

(30) Foreign Application Priority Data
Jul. 25, 2019 (CN) 201910680843.3

(51) Int. Cl. G06T 7/00; G06T 7/90; G06T 5/00; G06T 5/50

(52) U.S. Cl. CPC G06T 7/0004; G06T 5/50; G06T 5/003; G06T 7/90

(57) ABSTRACT

A method for processing images of assembly line objects for quality or other inspection acquires at least one first image of an object from an image capturing device, and recognizes image irradiation areas of different monochromatic lights of the acquired first image. The method further includes dividing each of the first image according to the recognized irradiation areas, generating at least one second image by integrating and stitching the divided first images under same monochromatic light, and outputting the at least one second image.

### CROSS-REFERENCE TO RELATED APPLICATIONS

This application claims priority to Chinese Patent Application No. 201910680843.3 filed on Jul. 25, 2019, the contents of which are incorporated by reference herein.

### FIELD

The subject matter herein generally relates to image processing.

### BACKGROUND

During assembly line production, it is necessary to carry out flaw detection on a surface of a product. A traditional flaw detecting method can project a plurality of colors on the product, and detect physical properties of the surface of the product according to physical characteristics of the reflected colors of light.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic diagram of an application environment architecture of a method of image processing of the present disclosure.

FIG. 2 shows one embodiment of a schematic structural diagram of a computer device of the present disclosure.

FIG. 3 shows a schematic diagram of surface illumination of a product object.

FIG. 4 is a flowchart of an embodiment of a method for processing images of the product object.

### DETAILED DESCRIPTION

In order to provide a more clear understanding of the objects, features, and advantages of the present disclosure, the same are given with reference to the drawings and specific embodiments. It should be noted that the embodiments in the present disclosure and the features in the embodiments may be combined with each other without conflict.

In the following description, numerous specific details are set forth in order to provide a full understanding of the present disclosure. The present disclosure may be practiced otherwise than as described herein. The following specific embodiments are not to limit the scope of the present disclosure.

Unless defined otherwise, all technical and scientific terms herein have the same meaning as used in the field of the art technology as generally understood. The terms used in the present disclosure are for the purposes of describing particular embodiments and are not intended to limit the present disclosure.

The present disclosure, referencing the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

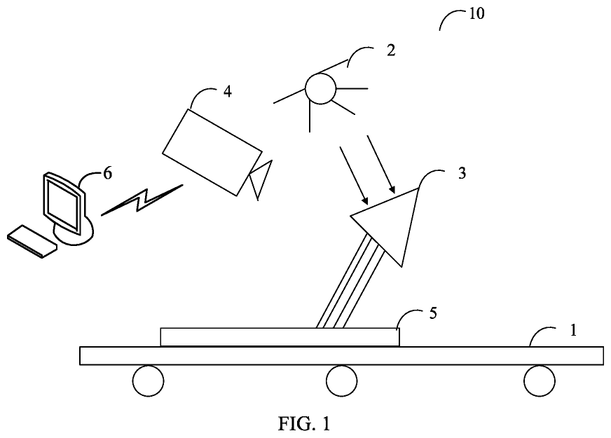

FIG. 1 is a schematic diagram of an application environment architecture of a method for image processing. The image processing method is applied to an object detecting system 10. The object detecting system 10 can include a transmission device 1, a light source 2, a spectrometer 3, and an image capturing device 4. The object to be detected is located on the transmission device 1. The image capturing device 4 is located above an assembly line. Capture angle of the image capturing device 4 is such that the object 5 to be detected can be completely photographed in the irradiation areas of different monochromatic lights. The light source 2 and the spectrometer 3 are located above the object 5 to be detected, and the spectrometer 3 is under the light source 2 and above the object 5. The image capturing device 4 communicates with a computer device 6 through network. The network may be a wired network or a wireless network, such as radio, WI-FI, cellular, satellite, broadcast, etc.

In at least one embodiment, the light source 2 can include, but is not limited to, an incandescent lamp, and an LED lamp.

In at least one embodiment, the spectrometer 3 can include, but is not limited to, a prism and a splitter. The spectrometer 3 receives light from the light source 2 and decomposes the received light into monochromatic lights of different colors.

In at least one embodiment, the spectrometer 3 is a splitter, and the light source 2 is an LED lamp. The splitter receives light from the LED lamp, and decomposes the received light into seven monochromatic lights of red light, orange light, yellow light, green light, cyan light, blue light, and purple light.

In at least one embodiment, the image capturing device 4 may be a camera having a photographing function. When the object 5 is moving with the transmission device 1 through illuminating areas of the monochromatic lights of different colors, the image capturing device 4 can collect a picture of the object 5 every time period and obtain a number of images.

In at least one embodiment, the time period is the time from the object 5 starts to be illuminated by a monochromatic light until the object 5 is fully illuminated by the monochromatic light, when the object 5 is moving with the transmission device.

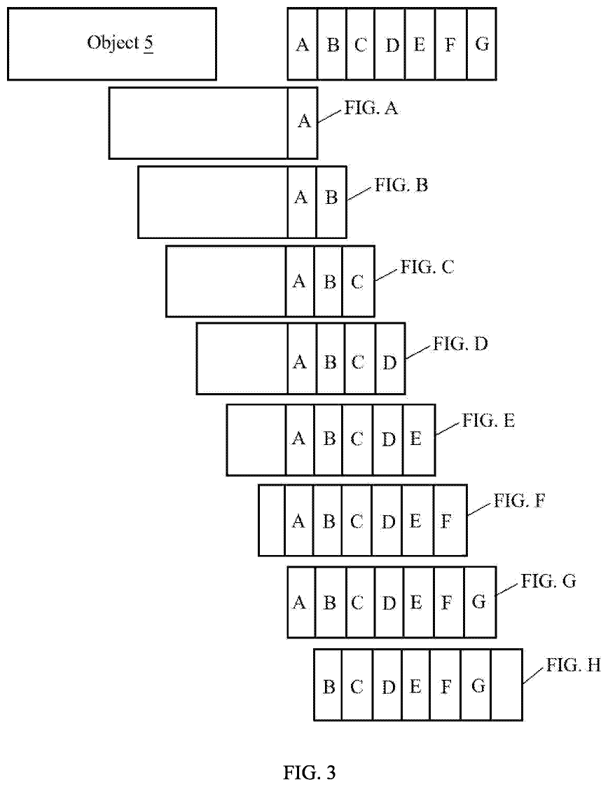

For example, FIG. 3 shows a schematic diagram of surface illumination of the object to be detected. The object 5 is moving through the irradiation area of purple light firstly. The time when the object 5 moving into the irradiation area of the purple light is t₀, and the time when the object 5 leaving the irradiation area of the purple light is t₁. Then, the time period T is calculated by a formula: T=t₁−t₀. Since the irradiation areas of different monochromatic lights are the same. The image capturing device 4 can obtain an image of the object 5 every time period under different monochromatic lights.

In other embodiments, the position of the spectrometer 3 can be adjusted. The image capturing device 4 can acquire images of the object 5 with high definition under different monochromatic lights by adjusting a distance between the spectrometer 3 and the light source 2.

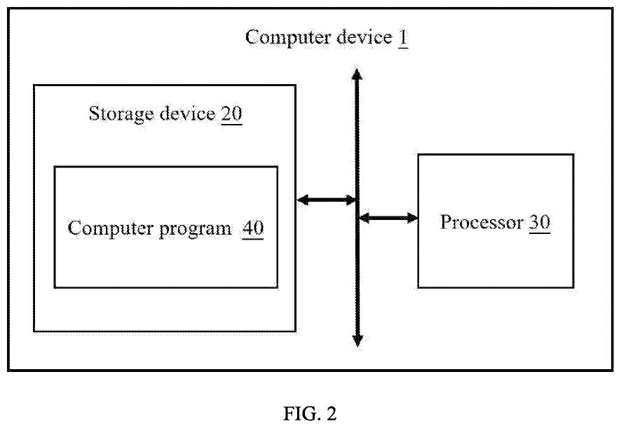

In at least one embodiment, the computer device 6 can be an electronic device having a function for processing images as shown in FIG. 2. The computer device 6 can include, but is not limited to, a storage device 20, at least one processor 30, and computer program 40 stored in the storage device 20, and executable on the processor 30. The computer program 40 can perform functions described below.

The computer device 6 can acquire at least one first image of the object 5, and acquire at least one second image which the object 5 is irradiated by the same monochromatic light as that used for the at least one first image.

In at least one embodiment, the computer device 6 can acquire at least one first image of the surface of the object 5 by the image capturing device 4. The image capturing device 4 can capture the at least one first image when the object is passing through several irradiation areas of different monochromatic lights. The several irradiation areas can include a first irradiation area, at least one middle irradiation area, and a final irradiation area. The several irradiation areas are sorted in order. For example, the image capturing device 4 can capture the at least one first image from the object 5 entering the first irradiation area to the object 5 leaving the final irradiation area.

In at least one embodiment, the computer device 6 can divide each of the at least one first image according to the irradiation area of each monochromatic light, and obtain divided images of the irradiation area of each monochromatic light, and generate the at least one second image by integrating the divided images under same monochromatic light.

In at least one embodiment, the computer device 6 can acquire each first image, and recognize one or more irradiation areas of different monochromatic light from the acquired first image by an image recognition method. The computer device 6 can divide the acquired first image based on the recognized irradiation areas.

In at least one embodiment, the image recognition method can include, but is not limited to, an image recognition method based on neural network, an image recognition method based on wavelet moment, and so on. The image recognition method is prior art, and details are not described herein.

For example, referring to FIG. 1 and FIG. 3, the image capturing device 4 can capture eight first images, the eight first images are captured from the object 5 entering the first irradiation area to the object 5 leaving the final irradiation area. For example, as shown in FIG. 3, the eight first images are captured from the object 5 entering the first irradiation area of the purple monochromatic light to the object 5 leaving the final irradiation area of the red monochromatic light. The eight first images are FIG. A, FIG. B, FIG. C, FIG. D, FIG. E, FIG. F, FIG. G and FIG. H.

In at least one embodiment, the FIG. A can include an irradiation area of the purple monochromatic light (A represents the irradiation area of the purple monochromatic light in FIG. 3). The FIG. B can include an irradiation area of the purple monochromatic light and an irradiation area of the blue monochromatic light (B represents the irradiation area of the blue monochromatic light in FIG. 3). The FIG. C can include an irradiation area of the purple monochromatic light, an irradiation area of the blue monochromatic light, and an irradiation area of the cyan monochromatic light (C represents the irradiation area of the cyan monochromatic light in FIG. 3). The FIG. D can include an irradiation area of the purple monochromatic light, an irradiation area of the blue monochromatic light, an irradiation area of the cyan monochromatic light, and an irradiation area of the green monochromatic light (D represents the irradiation area of the green monochromatic light in FIG. 3). The FIG. E can include an irradiation area of the purple monochromatic light, an irradiation area of the blue monochromatic light, and an irradiation area of the cyan monochromatic light, an irradiation area of the green monochromatic light, and an irradiation area of the yellow monochromatic light (E represents the irradiation area of the yellow monochromatic light in FIG. 3). The FIG. F can include an irradiation area of the purple monochromatic light, an irradiation area of the blue monochromatic light, an irradiation area of the cyan monochromatic light, an irradiation area of the green monochromatic light, an irradiation area of the yellow monochromatic light, and an irradiation area of the orange monochromatic light (F represents the irradiation area of the orange monochromatic light in FIG. 3). The FIG. G can include an irradiation area of the purple monochromatic light, an irradiation area of the blue monochromatic light, an irradiation area of the cyan monochromatic light, an irradiation area of the green monochromatic light, an irradiation area of the yellow monochromatic light, an irradiation area of the orange monochromatic light, and an irradiation area of the red monochromatic light (G represents the irradiation area of the red monochromatic light in FIG. 3). The FIG. H can include an irradiation area of the blue monochromatic light, an irradiation area of the cyan monochromatic light, an irradiation area of the green monochromatic light, an irradiation area of the yellow monochromatic light, an irradiation area of the orange monochromatic light, and an irradiation area of the red monochromatic light.

In at least one embodiment, the image capturing device 4 can send the eight first images to the computer device 6. The computer device 6 can recognize each of the eight first images by the image recognition method, and the computer device 6 can recognize each irradiation area of different monochromatic lights. For example, the computer device 6 can recognize the irradiation area of the purple monochromatic light of the FIG. A. The computer device 6 can recognize the irradiation area of the purple monochromatic light and the irradiation area of the blue monochromatic light of the FIG. B. The computer device 6 also can recognize the irradiation areas of different monochromatic lights of the FIG. C, the FIG. D, the FIG. E, the FIG. F, the FIG. G and the FIG. H.

In at least one embodiment, a method for generating the at least one second image by stitching the divided images of the object 5 when the object 5 is illuminated under same monochromatic light can include: acquire several divided images of the object 5 when the object 5 is illuminated by the same monochromatic light, recognize all portions of the object 5 from the divided images by the image recognition method, and label the divided images based on predetermined rules, and stitch the labeled images together.

In at least one embodiment, the predetermined rules can include dividing the acquired first image based on the recognized irradiation areas, and labeling the divided images according to the rule of parts of the object 5 from left to right, right to left, top to bottom, and bottom to top.

In at least one embodiment, the computer device 6 further can sharpen the integrated images to enhance the features of the images.

For example, the computer device 6 can acquire several divided images when the object 5 is illuminated under same monochromatic light, recognize all portions of the object 5 from the divided images by a neural network-based image recognition method, and label the recognized images based on the portions of the object 5 from left to right, and stitch the labeled images. For example, the computer device 6 can recognize portion A, portion B and portion C of the object 5 from the divided images. The portion B is connected with the portion C through the portion A from left to right. The computer device 6 can label a number one to the portion B, and label a number two to the portion A, and label a number three to the portion C. The computer device 6 further can sharpen the stitched images by using an image enhancement method to remove redundant information in the image, and enhance state information of the object to be measured under different color lights in the stitched images. The image enhancement method including a Laplacian image Enhancement method, and a histogram equalization enhancement method.

In at least one embodiment, the computer device 6 can output the stitched images.

In other embodiments, the computer device 6 can send the stitched images to other terminal device, and the other terminal device can output the stitched images. The other terminal device can include, but is not limited to, smart phone, tablet computer, and laptop computer.

In at least one embodiment, the computer device 6 can be a computing device such as a desktop computer, a notebook, a palmtop computer, and a cloud server. It will be understood by those skilled in the art that the schematic diagram is merely an example of the computer device 6, and does not constitute a limitation of the computer device 6, and other examples may include more or less components than those illustrated, or some components may be combined, or different. Components, such as the computer device 6, may also include input and output devices, network access devices, buses, and the like.

In at least one embodiment, the at least one processor 30 may be a central processing unit (CPU), and may also include other general-purpose processors, digital signal processors (DSPs), application specific integrated circuits (ASICs), and off-the-shelf programmable gate arrays, Field-Programmable Gate Array (FPGA) or other programmable logic device, discrete gate, or transistor logic device, discrete hardware components, etc. The general-purpose processor may be a microprocessor or the processor may be any conventional processor or the like. The processor 30 is control center of the computer device 1, and connects sections of the entire computer device 6 with various interfaces and lines.

In some embodiments, the storage device 20 can be used to store program codes of computer readable programs and various data, such as image processing method installed in the computer device 6. The storage device 20 can include a read-only memory (ROM), a random access memory (RAM), a programmable read-only memory (PROM), an erasable programmable read only memory (EPROM), a one-time programmable read-only memory (OTPROM), an electronically-erasable programmable read-only memory (EEPROM)), a compact disc read-only memory (CD-ROM), or other optical disk storage, magnetic disk storage, magnetic tape storage, or any other storage medium readable by the computer device 6.

The modules/units integrated by the computer device 6 can be stored in a computer readable storage medium if implemented in the form of a software functional unit and sold or used as a stand-alone product. The present disclosure implements all or part of the processes in the foregoing embodiments, and a computer program may also instruct related hardware. The computer program may be stored in a computer readable storage medium. The steps of the various method embodiments described above may be implemented by a computer program when executed by a processor. Wherein, the computer program comprises computer program code, which may be in the form of source code, product code form, executable file, or some intermediate form. The computer readable medium may include any entity or device capable of carrying the computer program code, a recording medium, a USB flash drive, a removable hard disk, a magnetic disk, an optical disk, a computer memory, a read-only memory (ROM), random access memory (RAM), electrical carrier signals, telecommunications signals, and software distribution media. It should be noted that the content contained in the computer readable medium may be increased or decreased according to the requirements of legislation and patent practice in a jurisdiction, for example, in some jurisdictions, computer-readable media is not defined to include electrical carrier signals and telecommunication signals.

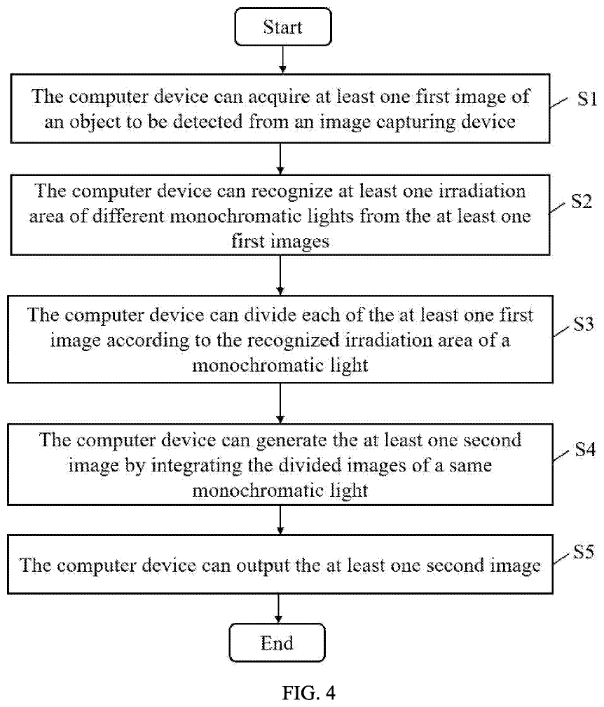

Referring to FIG. 4, the method is provided by way of example, as there are a variety of ways to carry out the method. Each block shown in FIG. 4 represents one or more processes, methods, or subroutines, carried out in the method. Furthermore, the illustrated order of blocks is illustrative only and the order of the blocks can be changed. Additional blocks can be added or fewer blocks can be utilized without departing from this disclosure. The example method can begin at block S1.

At block S1, the computer device 6 can acquire at least one first image of an object 5 from an image capturing device.

In at least one embodiment, the computer device 6 can acquire at least one first image of the surface of the object 5 by the image capturing device 4. The image capturing device 4 can capture the at least one first image when the object is passing through several irradiation areas of different monochromatic lights. The several irradiation areas can include a first irradiation area, at least one middle irradiation area, and a final irradiation area. The several irradiation areas are sorted in order. For example, the image capturing device 4 can capture the at least one first image from the object 5 entering the first irradiation area to the object 5 leaving the final irradiation area.

For example, referring to FIG. 1 and FIG. 3, the image capturing device 4 can capture eight first images, the eight first images are captured from the object 5 entering the first irradiation area to the object 5 leaving the final irradiation area. For example, as shown in FIG. 3, the eight first images are captured from the object 5 entering the first irradiation area of the purple monochromatic light to the object 5 leaving the final irradiation area of the red monochromatic light. The eight first images are FIG. A, FIG. B, FIG. C, FIG. D, FIG. E, FIG. F, FIG. G and FIG. H. The FIG. A can include an irradiation area of the purple monochromatic light (A represents the irradiation area of the purple monochromatic light in FIG. 3). The FIG. B can include an irradiation area of the purple monochromatic light and an irradiation area of the blue monochromatic light (B represents the irradiation area of the blue monochromatic light in FIG. 3). The FIG. C can include an irradiation area of the purple monochromatic light, an irradiation area of the blue monochromatic light, and an irradiation area of the cyan monochromatic light (C represents the irradiation area of the cyan monochromatic light in FIG. 3). The FIG. D can include an irradiation area of the purple monochromatic light, an irradiation area of the blue monochromatic light, an irradiation area of the cyan monochromatic light, and an irradiation area of the green monochromatic light (D represents the irradiation area of the green monochromatic light in FIG. 3). The FIG. E can include an irradiation area of the purple monochromatic light, an irradiation area of the blue monochromatic light, and an irradiation area of the cyan monochromatic light, an irradiation area of the green monochromatic light, and an irradiation area of the yellow monochromatic light (E represents the irradiation area of the yellow monochromatic light in FIG. 3). The FIG. F can include an irradiation area of the purple monochromatic light, an irradiation area of the blue monochromatic light, an irradiation area of the cyan monochromatic light, an irradiation area of the green monochromatic light, an irradiation area of the yellow monochromatic light, and an irradiation area of the orange monochromatic light (F represents the irradiation area of the orange monochromatic light in FIG. 3). The FIG. G can include an irradiation area of the purple monochromatic light, an irradiation area of the blue monochromatic light, an irradiation area of the cyan monochromatic light, an irradiation area of the green monochromatic light, an irradiation area of the yellow monochromatic light, an irradiation area of the orange monochromatic light, and an irradiation area of the red monochromatic light (G represents the irradiation area of the red monochromatic light in FIG. 3). The FIG. H can include an irradiation area of the blue monochromatic light, an irradiation area of the cyan monochromatic light, an irradiation area of the green monochromatic light, an irradiation area of the yellow monochromatic light, an irradiation area of the orange monochromatic light, and an irradiation area of the red monochromatic light.

At block S2, the computer device 6 can recognize at least one irradiation area of different monochromatic lights from the at least one first image.

In at least one embodiment, the image capturing device 4 can send the eight first images to the computer device 6. The computer device 6 can recognize each of the eight first images by the image recognition method, and the computer device 6 can recognize each irradiation area of different monochromatic lights of each first image. For example, the computer device 6 can recognize the irradiation area of the purple monochromatic light of the FIG. A. The computer device 6 can recognize the irradiation area of the purple monochromatic light and the irradiation area of the blue monochromatic light of the FIG. B. The computer device 6 also can recognize the irradiation areas of different monochromatic lights of the FIG. C, the FIG. D, the FIG. E, the FIG. F, the FIG. G and the FIG. H.

At block S3, the computer device 6 can divide each first image according to the recognized irradiation area of a monochromatic light.

In at least one embodiment, the computer device 6 can divide each first image according to the irradiation area of each monochromatic light, and obtain divided images of the irradiation area of each monochromatic light.

At block S4, the computer device 6 can generate the at least one second image by integrating the divided images under same monochromatic light.

In at least one embodiment, the computer device 6 can acquire each first image, and recognize one or more irradiation areas of different monochromatic lights from the acquired first image by an image recognition method. The computer device 6 can divide the acquired first image based on the recognized irradiation areas.

In at least one embodiment, a method for generating the at least one second image by stitching the divided images of the object 5 when the object 5 is illuminated under same monochromatic light can include: acquire at least one divided first images of the object when the object is illuminated by the same monochromatic light; recognize all portions of the object based on the acquired first images; label the recognized images based on the portions of the object by a predetermined rule; and generate at least one second image by stitching the labeled images together.

In at least one embodiment, the predetermined rules can include dividing the acquired first image based on the recognized irradiation areas, and labeling the divided images according to the rule of parts of the object 5 from left to right, right to left, top to bottom, and bottom to top.

At block S5, the computer device 6 can output the at least one second image.

In at least one embodiment, the computer device 6 can output the stitched images of the object 5. In other embodiments, the computer device 6 can send the stitched images to other terminal device, and the other terminal device can output the stitched images. The other terminal device can include, but is not limited to, smart phone, tablet computer, and laptop computer.

The above description is only embodiments of the present disclosure, and is not intended to limit the present disclosure, and various modifications and changes can be made to the present disclosure. Any modifications, equivalent substitutions, improvements, etc. made within the spirit and scope of the present disclosure is intended to be included within the scope of the present disclosure.

What is claimed is:

1. An image processing method applicable in a computer device, the method comprising:
acquiring at least one first image of an object to be detected from an image capturing device;
recognizing at least one irradiation area of different monochromatic lights from the at least one first image;
dividing each of the at least one first image according to the recognized irradiation area of a monochromatic light;
generating at least one second image by integrating the divided first image under same monochromatic light; and
outputting the at least one second image.

2. The method according to claim 1, wherein the at least one first image is captured by the image capturing device, when the object to be test is passing through a plurality of illuminating areas of a plurality of monochromatic lights of different colors of a light source.

3. The method according to claim 2, wherein the plurality of monochromatic lights of different colors of a light source are decomposed by a spectrometer.

4. The method according to claim 2, wherein the at least one first image is captured by the image capturing device every time period, and the time period T is calculated by a formula: T=t₁−t₀, wherein t₀ is the time when the object moving into an irradiation area of a monochromatic light, and t₁ is the time when the object leaving the irradiation area of the monochromatic light.

5. The method according to claim 1, wherein a method of generating at least one second image by integrating the divided first images under same monochromatic light comprising:
acquiring a plurality of divided first images of the object when the object is illuminated under same monochromatic light;
recognizing all portions of the object based on the acquired first images;
labeling the recognized images based on the portions of the object based on a predetermined rule; and
generating at least one second image by stitching the labeled images.

6. The method according to claim 1, wherein the method further comprising:
sharpening the at least one second image.

7. A computer device comprising:
a storage device;
at least one processor; and
the storage device storing one or more programs that, when executed by the at least one processor, cause the at least one processor to:
acquire at least one first image of an object to be detected from an image capturing device;
recognize at least one irradiation area of different monochromatic lights from the at least one first image;
divide each of the at least one first image according to the recognized irradiation area of a monochromatic light;
generate at least one second image by integrating the divided first image under same monochromatic light; and
output the at least one second image.

8. The computer device according to claim 7, wherein the at least one first image is captured by the image capturing device, when the object to be test is passing through a plurality of illuminating areas of a plurality of monochromatic lights of different colors of a light source.

9. The computer device according to claim 8, wherein the plurality of monochromatic lights of different colors of a light source are decomposed by a spectrometer.

10. The computer device according to claim 8, wherein the at least one first image are captured by the image capturing device every time period, and the time period T is calculated by a formula: T=t₁−t₀, wherein t₀ is the time when the object moving into an irradiation area of a monochromatic light, and t₁ is the time when the object leaving the irradiation area of the monochromatic light.

11. The computer device according to claim 7, wherein the at least one processor is further caused to:
acquire a plurality of divided first images of the object when the object is illuminated under same monochromatic light;
recognize all portions of the object based on the acquired first images;
label the recognized images based on the portions of the object based on a predetermined rule; and
generate at least one second image by stitching the labeled images.

12. The computer device according to claim 7, wherein the at least one processor is further caused to:
sharpen the at least one second image.

13. A non-transitory storage medium having stored thereon instructions that, when executed by a processor of a computer device, causes the processor to perform an image processing method, the method comprising:
acquiring at least one first image of an object to be detected from an image capturing device;
recognizing at least one irradiation area of different monochromatic lights from the at least one first image;
dividing each of the at least one first image according to the recognized irradiation area of a monochromatic light;
generating at least one second image by integrating the divided first image under same monochromatic light; and
outputting the at least one second image.

14. The non-transitory storage medium according to claim 13, wherein the at least one first image is captured by the image capturing device, when the object to be test is passing through a plurality of illuminating areas of a plurality of monochromatic lights of different colors of a light source.

15. The non-transitory storage medium according to claim 14, wherein the plurality of monochromatic lights of different colors of a light source are decomposed by a spectrometer.

16. The non-transitory storage medium according to claim 14, wherein the at least one first image is captured by the image capturing device every time period, and the time period T is calculated by a formula: T=t₁−t₀, wherein t₀ is the time when the object moving into an irradiation area of a monochromatic light, and t₁ is the time when the object leaving the irradiation area of the monochromatic light.

17. The non-transitory storage medium according to claim 13, wherein a method of generating at least one second image by integrating the divided first images under same monochromatic light comprising:
acquiring a plurality of divided first images of the object when the object is illuminated under same monochromatic light;
recognizing all portions of the object based on the acquired first images;
labeling the recognized images based on the portions of the object based on a predetermined rule; and
generating at least one second image by stitching the labeled images.

18. The non-transitory storage medium according to claim 13, wherein the method further comprising:
sharpening the at least one second image.
